(19) United States
(12) Patent Application Publication
(10) Pub. No.: US 2014/0138247 A1
(43) Pub. Date: May 22, 2014

(54) APPARATUS AND METHOD FOR WATER TREATMENT MAINLY BY SUBSTITUTION USING A DYNAMIC ELECTRIC FIELD

(71) Applicants: Ove T. Aanensen, Kristiansand (NO); Dag Arild Valand, Wachtberg (DE)

(72) Inventors: Ove T. Aanensen, Kristiansand (NO); Dag Arild Valand, Wachtberg (DE)

(21) Appl. No.: 13/683,212

(22) Filed: Nov. 21, 2012

(51) Int. Cl. C02F 5/02

(52) U.S. Cl. CPC C02F 5/02
USPC 204/571; 204/660; 204/554

(57) ABSTRACT

An apparatus, method, process, and system for the treatment of a water stream are provided. Such apparatus, method, process, and system characterized by applying a voltage to a pair of electrodes to generate an electric field with such electric field applied across a water stream passing there between the pair of electrodes. At least one of the pair of electrodes comprises a metal, and one or more of a plurality of positively charged ions in the water stream are substituted with one or more positively charged ions of the metal. Additionally, one or more of a plurality of negatively charged ions may react with the one or more positively charge ions of the metal to form an ionic compound. One or more of any remaining of the plurality of positively charged ions may reaction with another one or more of the plurality of negatively charged ions.

### TECHNOLOGICAL FIELD

Embodiments of the present invention relate generally to water treatment and, more specifically, to an apparatus and a process for the treatment of water to prevent scaling in processes that utilize water.

### BACKGROUND

Calcium occurs in water naturally due to its natural occurrence in the earth's crust. Freshwater rivers may have calcium concentrations as high as 100 ppm. The amount of calcium is determinative of the hardness of water. Elemental calcium readily reacts with water at room temperature to form calcium hydroxide (Ca(OH)₂) and hydrogen gas according to the following reaction mechanism:

Ca+2H₂O→Ca(OH)₂+H₂ (1)

The earth also has an abundance of limestone and other calcite-based deposits through which water can percolate. Under normal conditions, the solubility of calcium carbonate in water is 14 mg/L. However, in the presence of carbon dioxide (CO₂), carbonic acid (H₂CO₃) is formed in water according to the following reaction mechanism:

CO₂+H₂O⇄H₂CO₃ (2)

In the presence of carbonic acid, the solubility of calcium carbonate increases by about a factor of five and more readily dissolves in water to form calcium (Ca²⁺) and bicarbonate (HCO₃⁻) ions according to the following reaction mechanisms:

CaCO₃+H₂CO₃⇄Ca(HCO₃)₂ (3)

Ca(HCO₃)₂⇄Ca²⁺(aq)+2HCO₃⁻(aq) (4)

While calcium is a dietary mineral with its presence in water causing no real harm to the body, the presence of calcium in water, or more particularly, the presence of calcium and bicarbonate ions may impact systems that rely upon the use of water. For example, with increasing temperature, the density of carbon dioxide in water decreases and the equilibrium conditions of reactions (2) and (3) shift to the left causing calcium carbonate to form and precipitate from the water. Thus hot surfaces in water systems become susceptible to fowling or the deposit of solids on such surfaces in, for example, hot water heaters in houses and boilers used in industrial processes.

Piping systems and/or processes that transport and utilize water may often accumulate mineral deposits as a result of fouling. For example, particulate fouling occurs when mineral ions present in an aqueous stream combine to form particles that settle onto the surfaces of piping systems and/or processes. Precipitation fouling may result when ions leave the aqueous solution and form hard crystalline deposits or scaling that becomes adhered to the inside surface of a pipe or process equipment.

Fouling can lead to deterioration in performance of processes. For example, scaling in heat exchangers causes a reduction in efficiency of the heat exchanger. The problem with scaling in these systems may be further compounded by an inverse solubility effect in water systems. For example the solubility of certain mineral compounds in water, such as CaCO₃ for example, decreases as the temperature of the water increases causing the dissolved mineral ions to precipitate from the water and become deposited at the surface of the equipment.

Prior art methods to prevent scaling in piping systems and process equipment predominantly involve the removal of minerals from the water using physical water treatment methods such as bulk precipitation of ionic compounds from the water prior to introducing the water into the piping system or the process equipment. Bulk precipitation water processing techniques typically involves introducing seed particles into the water that combine with ions in the water to form larger particles that can more easily be precipitated from the stream.

Conventionally, decalcification techniques have also relied upon the use of treating the water with chemicals either to impede fouling or through the additional of special salts that cause an exchange of the ions in the water that are more prone to precipitating in downstream processes with ions that are less prone to precipitating in downstream processes.

Certain prior art processing techniques have also employed the use of an electric field to facilitate the attraction of Ca²⁺ ions to HCO₃⁻ ions and encourage the precipitation of solids from the water stream. However, electric fields have not proven to be affective in reversing the formation of scale in process systems, because they generally cannot provide a strong enough electric field in the water to induce bulk precipitation.

Bulk precipitation methods of the prior art have also utilized induced electric fields to stimulate the collisions of dissolved mineral ions in an attempt to accelerate the combination and resulting precipitation of these combined ions in these water treatments systems.

There is a need in the art for improved processes and processing equipment for the removal of minerals from water to prevent fouling in piping systems and process that further utilize the processed water. There is a further need in the art for the removal of ions in water that do not require the use of chemical treatment or additives in the water.

### BRIEF SUMMARY OF EXEMPLARY EMBODIMENTS

Embodiments of the present invention are therefore provided for the treatment of water. The treated water may be used, for example, in downstream equipment or processes to reduce or eliminate scaling.

An aspect of the invention provides an ionic reactor comprising one or more cells with each cell comprising a pair of electrodes. At least one of the pair of electrodes in each cell comprises a metal. A water stream comprising a plurality of positively charged ions and a plurality of negatively charged ions flows through the one or more cells of the ionic reaction. A voltage is applied to the pair of electrodes to generate an electric field through the water stream. One or more of the plurality of positively charged ions are substituted by one or more positively charged ions of the metal.

In an embodiment of the invention, one or more of the plurality of negatively charged ions are reacted with the one or more positively charged ions of the metal to form an ionic compound. In certain embodiments of the invention, one or more unsubstituted plurality of positively charged particles may be reacted with another one or more of the plurality of negatively charged particles to form another ionic compound.

In certain embodiments of the invention, the ionic reactor also comprises a separator that is configured to remove the ionic compound and any of the other ionic compounds that may have formed in the water stream.

According to certain embodiments of the invention, the voltage may be an alternating voltage. In certain embodiments of the invention, the voltage is defined by a waveform and the waveform is any one of a sinusoidal wave, a square wave, a trapezoidal wave, and any combination thereof.

According to an embodiment of the invention, the metal may comprise magnesium. In certain embodiments of the invention, the metal may comprise aluminum. In certain embodiments of the invention, the metal may comprise both magnesium and aluminum.

An aspect of the invention provides a method for treatment of water comprising the steps of providing a water stream having a plurality of positively charged ions and negatively charged ions; flowing the water stream between a first electrode and a second electrode, at least one of the first electrode and the second electrode comprising a metal; generating an electric field across the water stream by applying a voltage across the first electrode and the second electrode; and substituting one or more of the plurality of positively charged ions with one or more positively charged ions of the metal.

In an embodiment of the invention, the method of treatment of water may additionally comprise the step of reacting one or more of the plurality of negatively charged ions with the one or more positively charged ions of the metal to form an ionic compound. In yet other embodiments of the invention, the method of treatment of water may additionally comprise reacting one or more of any remaining plurality of positively charged ions with another one or more of the plurality of negatively charged ions to form another ionic compound.

In certain embodiments of the invention, the method of treatment of water includes removing the ionic compound and any of the another ionic compound from the water stream.

In an embodiment of the invention, the metal is any one of magnesium, aluminum, and any combination thereof.

An aspect of the invention provides a system for the treatment of water comprising a reactor. The reactor one or more cells, each cell comprising a pair of electrodes, at least one of the pair of electrodes having a metal; a water stream comprising a plurality of positively charged ions and a plurality of negatively charged ions, the water stream flowing through the one or more cells; and a voltage applied to the pair of electrodes to generate an electric field through the water stream.

It is to be understood that the foregoing general description and the following detailed description are exemplary, and are not intended to limit the scope of the invention. These embodiments of the invention and other aspects and embodiments of the invention will become apparent upon review of the following description taken in conjunction with the accompanying drawings. The invention, though, is pointed out with particularity by the appended claims.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 illustrates an ionic reactor that processes a water stream, according to an embodiment of the invention, prior to being sent in a boiler;

FIG. 2 illustrates a single cell ionic reactor according to an embodiment of the invention;

FIG. 3 is a graphical representation of relative water conductivity versus the duration of electric field treatment according to certain embodiments of the invention;

FIG. 4A illustrates a stack type, multi-cell ionic reactor according to an embodiment of the invention;

FIG. 4B illustrates a cross-sectional view of the stack type, multi-cell ionic reactor taken along the sectioning line BB′ of FIG. 4A;

FIG. 5A illustrates a tube type, multi-cell ionic reactor according to an embodiment of the invention;

FIG. 5B illustrates a cross-sectional view of the tube type, multi-cell ionic reactor taken along the sectioning line BB′ of FIG. 5A;

FIG. 6A is a graphical representation of relative conductivity versus duration of treatment for varying field strengths according to an embodiment of the invention;

FIG. 6B is a graphical representation of relative conductivity versus field strength for varying durations of treatment according to an embodiment of the invention;

FIG. 7A is a graphical representation of relative conductivity versus duration of treatment for varying field strengths according to another embodiment of the invention;

FIG. 7B is a graphical representation of relative conductivity versus field strength for varying durations of treatment according to another embodiment of the invention;

FIG. 8A is a graphical representation of relative conductivity versus duration of treatment for varying field strengths according to yet another embodiment of the invention;

FIG. 8B is a graphical representation of relative conductivity versus field strength for varying durations of treatment according to yet another embodiment of the invention; and

FIG. 9 is a process flow diagram showing the steps of a method for treatment of water according to an exemplary embodiment of the invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements.

As used in the specification and in the appended claims, the singular forms “a”, “an”, and “the” include plural referents unless the context clearly indicates otherwise. For example, reference to “an electric field” includes a plurality of such electric fields.

Although specific terms are employed herein, they are used in a generic and descriptive sense only and not for purposes of limitation. All terms, including technical and scientific terms, as used herein, have the same meaning as commonly understood by one of ordinary skill in the art to which this invention belongs unless a term has been otherwise defined. It will be further understood that terms, such as those defined in commonly used dictionaries, should be interpreted as having a meaning as commonly understood by a person having ordinary skill in the art to which this invention belongs. It will be further understood that terms, such as those defined in commonly used dictionaries, should be interpreted as having a meaning that is consistent with their meaning in the context of the relevant art and the present disclosure. Such commonly used terms will not be interpreted in an idealized or overly formal sense unless the disclosure herein expressly so defines otherwise.

As used herein, “carbonate ions” or “CO₃²⁻” may interchangeably mean carbonate (CO₃²⁻) or carbonate in the form of bicarbonate (HCO₃⁻) in aqueous solutions. As further used herein, “calcium carbonate” or “CaCO₃” may interchangeably mean calcium carbonate or calcium bicarbonate (Ca(HCO₃)₂). In reality, calcium bicarbonate is not known to exist as a solid compound, but is a form that may be expressed to exist in an aqueous solution that contains calcium (Ca²⁺), bicarbonate (HCO₃⁻), and carbonate ions (CO₃²⁻) together with dissolved carbon dioxide in such solutions.

As used herein, “ionic reactor” includes a device of the invention, methods and processes of the invention embodied in such a device, and/or systems of the invention that utilize such a device and/or methods. Without intending to be bound by theory, water that has been treated using the ionic reactor and methods thereof, exiting the ionic reactor has a reduced ionic concentration or low ion-density or ionic-density and substantially reduces and/or eliminates altogether scaling in downstream devices, methods, processes, and/or systems that utilize the water treated in the ionic reactor. Indeed, many of these devices, methods, processes, and/or systems may operate at higher temperatures and/or increases the temperature of the water, but the extent of scaling in such devices, methods, processes, and/or systems may be substantially reduced or even eliminated in comparison to using water that has not been treated using the device, methods, processes, and/or systems of the invention.

The inventors have conceived that of devices, systems, and methodologies that prevent the undesirable formation and precipitation of CaCO₃ that leads to scaling in devices, systems, and/or methods that utilize water. For example, without intending to be bound by theory, a reduction in concentrations of the scale-forming ions reduces the frequency of collisions between the ions. Ions must collide before they can form the scale-forming ionic compounds. Thus a reduction in the frequency of collisions between the ions results in a reduction in the extent of formation of scale-forming ionic compounds.

Indeed, the probability of a collision between ionic species that results in a scale-forming ionic compound is proportional to the concentration or density of the ions in the water. However, in addition to colliding, the ions must have a certain minimum kinetic energy to overcome the activation energy required for formation of the scale-forming ionic compound.

An object of the invention provides a method, a process, and/or a system for the prevention of scaling due to the unwanted precipitation of calcium carbonate from water used in these processes or downstream processes using, for example, water treated according to the methods, processes, and/or systems of the invention. Generally, the water fed in these systems comprises Ca²⁺ ions and CO₃²⁻ ions, which is more aptly in the form of HCO₃⁻ ions. In certain embodiments of the invention, the water fed in these systems may have substantial concentrations of Ca²⁺ ions and CO₃²⁻ ions. In certain embodiments of the invention, the water fed in these systems may be supersaturated with Ca²⁺ ions and CO₃²⁻ ions.

The concentration or density of Ca²⁺ ions and CO₃²⁻ or HCO₃⁻ ions may be reduced in the ionic reactor by any one or any combination of three different mechanisms. The first mechanism that may be used to reduce the concentration or density of Ca²⁺ ions and CO₃²⁻ or HCO₃⁻ ions is substitution. Water is directed to flow between the two electrodes in the ionic reactor. As further disclosed herein, different materials may be used for the two electrodes in the ionic reactor. The electrodes generate an electric field, in certain embodiments of the invention, an alternating electric field, across the water flowing between the electrodes. In certain embodiments of the invention, the alternating electric field may be a pulsed, alternating electric field.

The electric field energy is such that it imparts to the Ca²⁺ ions a sufficient kinetic energy to exceed or overcome the metallic-lattice binding energy of the metal of the electrode causing the metal of the electrode to be substituted with the calcium atoms. The total velocity of the ion is the velocity imparted by the electric field force added to the Brownian movement. In certain cases, ions combined, for example, with “attached ions” of opposite polarity will be given a high enough velocity and energy such that they will lose the attached ions causing a further increase in the ion's own velocity and energy. The metal or metals used in the electrodes that are to be substituted for the Ca²⁺ ions in water are selected such that they a less susceptible to forming ionic compounds than the Ca²⁺ ions are in downstream processes.

The second type of mechanism that may be used to reduce or eliminate scaling in downstream processing involves neutralizing the CO₃²⁻ or HCO₃⁻ ions in the water through the formation of a metallic carbonate in the ionic reactor. For example, if magnesium is selected to be the metallic element to substitute with Ca²⁺, then magnesium carbonate (MgCO₃) is formed in the ionic reactor. As disclosed herein, atoms or ions in solution must collide before such atoms or ions can react with each other. Additionally, not every collision is effective in forming an ionic compound—i.e., the atoms or ions may not possess the minimum amount of kinetic energy required to achieve the activation energy needed before the reaction can occur.

According to certain embodiments of the invention, the electric field is dynamic or changing. In an exemplary embodiment of the invention, the use of an alternating electric field across the water flowing between the two electrodes in the ionic reactor causes the substituted positive metallic ions, for example, Mg²⁺ ions according to a specific embodiment of the invention, in water to move toward the negative electrode and the negative CO₃²⁻ or HCO₃⁻ ions to move toward the positive electrode. In addition to causing these ions to move in opposite directions, which increases the probability that they will collide, the electric field also imparts sufficient kinetic energy to the ions allowing them to exceed the activation needed for the reaction to occur once they do collide. Furthermore, in the embodiment of the invention directed to the use of a dynamic electric field, for example, an alternating electric field, the directional movement of the ions change once the field is alternated and the polarity of the electrodes change. Thus, the alternating electric field creates a dynamic and dispersed solution of both positive and negative ions constantly in movement with an increased probability that the two will collide to form a metallic carbonate combination such as MgCO₃ according to certain embodiments of the invention.

The choice of metal used to substitute with Ca²⁺ may also determine whether this second mechanism of neutralizing CO₃²⁻ or HCO₃⁻ ions in the water is plausible. For example, if aluminum is chosen as the metal to substitute with the Ca²⁺ ions, then any formed aluminum carbonate (Al₂(CO₃)₃), which is an unstable compound, readily decomposes to aluminum hydroxide (AL(OH)₃) and carbon dioxide (CO₂) according to the following reaction:

Al₂(CO₃)₃+3H₂O→2Al(OH)₃+3CO₂ (5)

Special provisions would have to be provided to degas the ionic reactor due to the formation of the CO₂, not to mention the possible need for further processing of off-gas, although Al(OH)₃ is highly insoluble in water and would precipitate. However, as further disclosed herein, the use of aluminum as a substitution metal as well as a metal to neutralize CO₃²⁻ or HCO₃⁻ ions in the water may be less preferred than other metals, such as, for example, magnesium.

A third type of mechanism for reducing the concentration of Ca²⁺ ions and CO₃²⁻ or HCO₃⁻ ions in water, though less preferred over the substitution and neutralization mechanism disclosed herein is by rebuilding calcium carbonate, CaCO₃, in the ionic reactor. Calcium carbonate may be rebuilt in the ionic reactor by first forming a plurality of crystal seeds in the water around which calcium carbonate may continue to form. In certain embodiments of the invention, this third mechanism may be used, for example, to remove or scavenger any remaining Ca²⁺ ions that were unable to substitute with the metal in the metal lattice framework of the electrode.

In an embodiment of the invention, the reduction in concentration or density of Ca²⁺ ions and CO₃²⁻ or HCO₃⁻ ions is primarily through the substitution mechanism. In certain embodiments of the invention, the reduction in concentration or density of Ca²⁺ ions and CO₃²⁻ or HCO₃⁻ ions is through the substitution mechanism and the formation of metallic carbonate as described herein. In yet other embodiments of the invention, the reduction in concentration or density of Ca²⁺ ions and CO₃²⁻ or HCO₃⁻ ions is through the substitution mechanism and, at least one of, the formation of metallic carbonate and the rebuilding of calcium carbonate.

In certain embodiments of the invention, any of these mechanisms or combinations of these mechanisms may be used without additional chemical treatment of the water. Yet, in certain other embodiments of the invention, any of these mechanisms or combinations of these mechanisms may be supplemented with chemical additives or additional chemical treatments of the water.

The method, process, and/or system of the invention neutralize the Ca²⁺ ions and CO₃²⁻ ions, without the use of chemical additives, reduces or prevents the formation of CaCO₃, which could cause scaling in the equipment associated with these processes. The inventors have conceived of substituting the Ca²⁺ ions with another metallic ion thus neutralizing the potential of the Ca²⁺ ions in the water from combining with the CO₃²⁻ ions in the water preventing the formation of the compound responsible for scaling in the equipment of these water systems.

For example, a physical method may be used to force the Ca²⁺ ions to be substituted for another metallic ion or even other metallic ions. In an embodiment of the invention, the source of the metallic ion or metallic ions may be one or more metallic electrodes. The CO₃²⁻ ions may be forced to combine with the metallic ions present in the water to cause the formation of a metallic carbonate.

These one or more metallic electrodes may be disposed in water volume element or a reactor, further referenced to herein as the “ionic reactor.” In an embodiment of the invention, the water may flow between, for example, two metallic electrodes causing the water to become under-saturated with ions reducing the possibility for the formation of CaCO₃ and eliminating scaling in the systems where the water is subsequently used. For example, the ionic reactor may be configured and may be operated such that the concentration of scale-forming ions remaining in the water is reduced to suppress scaling in portions of the process that operate at elevated temperatures.

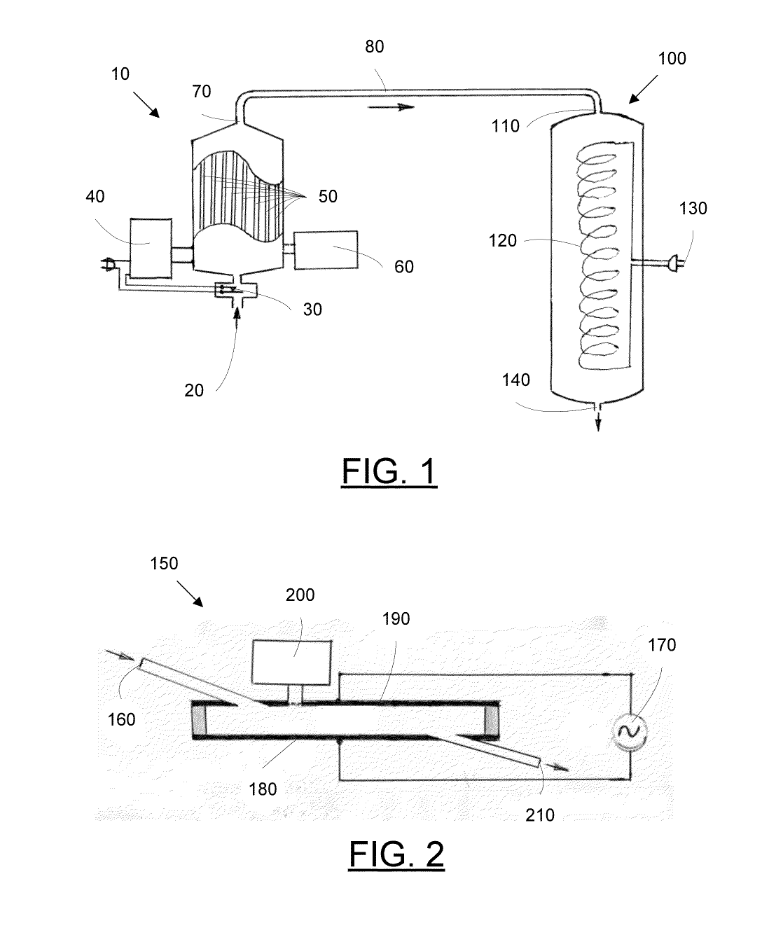

FIG. 1 illustrates an ionic reactor 10 that processes a water stream, according to an embodiment of the invention, prior to being sent to a downstream process or downstream processes such as a boiler 100. In the illustrative embodiment of FIG. 1 an ionic reactor 10 is placed in the water stream prior to being introduced to another process. Water enters the ionic reactor 10 at reactor inlet 20. In certain embodiments of the invention, the ionic reactor 10 is configured to become activated when water enters the ionic reactor 10 at the reactor inlet 20. The incoming water causes switch 30 to be activated causing power to be supplied through a power supply or, according to this exemplary embodiment, an AC power supply 40 to a plurality of electrodes 50.

Thus, the imposed electric field or, according to this exemplary embodiment, an alternating electric field treats a multiplicity of volume elements of the water flowing between the electrodes increasing the probability that Ca²⁺ ions become substituted with metal atoms in the metallic lattice of the electrodes. Additionally, the electric field or, according to this exemplary embodiment, the alternating electric field increases the probability of collisions between ions, moreover, increases the probability of collisions and ensures the velocity of the colliding ions is such that the reaction of the substituted metallic ions with the CO₃²⁻ ions will occur causing the CO₃²⁻ ions in the water to be removed or neutralized. Any Ca²⁺ ion that has not substituted with a metal atom of the metallic lattice of the electrode may collide with CO₃²⁻ or HCO₃⁻ ions causing CaCO₃ to form and precipitate in the ionic reactor 10.

In certain embodiments of the invention the electrodes comprise magnesium Ca2+ ions are substituted with Mg²⁺ ions from the metallic lattice of the electrode. Furthermore, the CO₃²⁻ or HCO₃⁻ ion neutralization results in the formation of MgCO₃ in the ionic reactor 10. Of course, as further disclosed herein, the CO₃²⁻ or HCO₃⁻ ions may also be neutralized by Ca²⁺ ions that have not become substitute with metallic ions from the electrode. Thus, the formed metallic carbonate, which is MgCO₃ according to this specific embodiment of the invention, and any formed CaCO₃ may be precipitated and collected from the ionic reactor 10. According to certain embodiments of the invention, the velocity of the water is such that the formed metallic carbonate, which is MgCO₃ according to this specific embodiment of the invention, and any formed CaCO₃ may be entrained in the water and carried with the treated water exiting the ionic reactor 10 at the reactor outlet 70. In this embodiment of the invention, the metallic carbonate, for example MgCO₃ according to this specific embodiment of the invention, and any CaCO₃ that has been formed must be removed from the treated water after it exits the ionic reactor 10.

An ultra-sonic transmitter 60 may be used to prevent the buildup of sediment layers along the electrodes 50 of the ionic reactor 10. The treated water exits the ionic reactor 10 at reactor outlet 70 and flows to boiler 100 via piping system 80.

As further disclosed herein, the extent of reduction of the ionic density in the treated water is dependent upon the residence time or retention time of the water in the ionic reactor 10. For example, the residence time of water in the ionic reactor 10 may be determined by certain design parameters of the ionic reactor 10. For example, the volume of the ionic reactor 10 will establish the residence time of the water in the reactor. Other design factors that may influence the residence time of water in the ionic reactor 10 include whether the water travels through multiple cells in the ionic reactor 10 and whether such flow arrangements are in series, parallel, or a combination thereof. The residence time of the water in the ionic reactor 10 may also be influenced by the velocity of the water in the ionic reactor 10.

The ionic density of the treated water may be controlled, for example, by measuring the conductivity of the water to determine the concentration of ions remaining in the treated water. According to certain embodiments of the invention, a controller may reset certain control parameters to achieve a targeted reduction in conductivity, for example. In certain embodiments of the invention, the controller may reset the flow rate of the water to the ionic reactor 10 to establish the needed residence or retention time for the water in the ionic reactor 10. In certain other embodiments of the invention, the controller may reset the intensity of the electric field in the ionic reactor 10. In yet certain other embodiments of the invention, the controller may reset the flow rate of the water to the ionic reactor 10 and the intensity of the electric field in the ionic reactor 10.

In an embodiment of the invention, the conductivity of the treated water exiting the ionic reactor 10 is less than about 50% of the conductivity of the raw water entering the ionic reactor 10. In certain embodiments of the invention, the conductivity of the treated water exiting the ionic reactor 10 is less than about 25% of the conductivity of the raw water entering the ionic reactor 10. In yet certain other embodiments of the invention, the conductivity of the treated water exiting the ionic reactor 10 is less than about 10% of the conductivity of the raw water entering the ionic reactor 10. In yet even other embodiments of the invention, the conductivity of the treated water exiting the ionic reactor 10 is less than about 5% of the conductivity of the raw water entering the ionic reactor 10. In certain embodiments of the invention, the conductivity of the treated water exiting the ionic reactor 10 may be less than about 1% of the conductivity of the raw water entering the ionic reactor 10.

The reaction velocity to form calcium carbonate and scaling deposits in the downstream processes will be reduced by an amount equivalent to the squared value of the reduction in concentration or density of the Ca²⁺ and CO₃²⁻ ions. For example, when the concentration or density of the Ca²⁺ and CO₃²⁻ ions are reduced by 25%, the reaction velocity of the combination of these ions in downstream equipment is reduced by (¼)² or 1/16 in comparison to the reaction velocity of the compounds in the untreated or raw water.

According to the illustrative embodiment of FIG. 1, the treated water enters the boiler 100 at boiler inlet 110 where it is heated by heating elements 120. In the illustrative embodiment represented by FIG. 1, the boiler is an electric boiler and electrical energy supplied through an AC power supply 130 heats the heating elements 120. In other embodiments of the invention, other non-limiting examples of the boiler 100 that may be used include one or more of a steam boiler, a fired boiler, a waste heat boiler, a fluidized bed combustion boiler, a thermic fluid boiler, and a renewable energy boiler. The heated water and/or steam exits the boiler 100 at the boiler outlet 140.

FIG. 2 illustrates a single cell ionic reactor 150 according to an embodiment of the invention. Water enters the single cell ionic reactor 150 at a reactor inlet 160. In the illustrative embodiment of FIG. 2, an AC power supply 170 supplies power to the metallic electrode surfaces or electrodes 180 & 190 to generate an alternating electric field. The water flows between the electrodes 180 & 190, which generate an electric field through the water as it flows between the electrodes 180 & 190. In an embodiment of the invention, an alternating electric field is generated. In an embodiment of the invention, a voltage is applied across the electrodes 180 & 190 to generate the electric field. In an embodiment of the invention, the voltage may be an alternating voltage. In certain embodiments of the invention, the voltage is configured to have a pattern. Without intending to be limiting, but only by way of example, the voltage may be configured to be at least one of a sinusoidal wave, a square wave, a trapezoidal wave, and any combination thereof.

In certain embodiments of the invention, a pulsed alternating electric field is generated. In certain other embodiments of the invention a DC power supply (not shown) may supply power to the electrodes generating a direct current electric field. In yet certain other embodiments of the invention, the electric field is a pulsed direct current electric field. In even yet other embodiments of the invention, any of the direct current electric fields, including a pulsed direct current electric field, may be configured to invert the signal causing the polarity of the electrodes to change. Further pursuant to this embodiment of the invention, the pulsed electric field would be configured to invert over a certain frequency.

The electrical field strength may be from about 1 kV/m to about 300 kV/m, from about 5 kV/m to about 150 kV/m, from about 10 kV/m to about 100 kV/m, from about 25 kV/m to about 75 kV/m, and from about 30 kV/m to about 50 kV/m. In certain embodiments of the invention, the electric field strength may be about 40 kV/m.

An ultra-sonic transmitter 200 may be used to prevent the buildup of sediment layers along the electrodes 180 & 190 of the ionic reactor 150. Treated water leaves the single cell ionic reactor 150 at the reactor outlet 210.

In certain embodiments of the invention, an electrode may be an aluminum electrode or may be an electrode comprising aluminum (Al) atoms in the metal lattice of the electrode. Al atoms in the metal lattice of the electrode may be substituted by Ca atoms under, for example, the conditions described above. The aluminum atom has 3 valence electrons; thus, the charge of an aluminum ion is positive 3. The calcium atom has 2 valence electrons; thus, as shown earlier, the charge of a calcium ion is positive 2. Therefore, three (3) Ca atoms are needed to substitute two (2) Al atoms in the metal lattice structure of the electrode.

In certain embodiments of the invention, an electrode may be an magnesium electrode or may be an electrode comprising magnesium (Mg) atoms in the metal lattice of the electrode. Ca atoms and Mg atoms both have 2 valence electrons. Thus, one (1) Ca atom is needed to substitute with one (1) Mg atom in the metal lattice structure of the electrode. Similar to the collision theory described earlier, because only one Ca atom needs to be in the vicinity of a Mg atom in the metal lattice of the electrode to substitute with the Mg atom, whereas more Ca atoms need to be in the vicinity of an Al atom (i.e., three Ca atoms for every two Al atoms) in the metal lattice of the electrode to substitute with the Al atom, substitution of Mg atoms by Ca atoms have a higher substitution probability than substitution of Al atoms by Ca atoms.

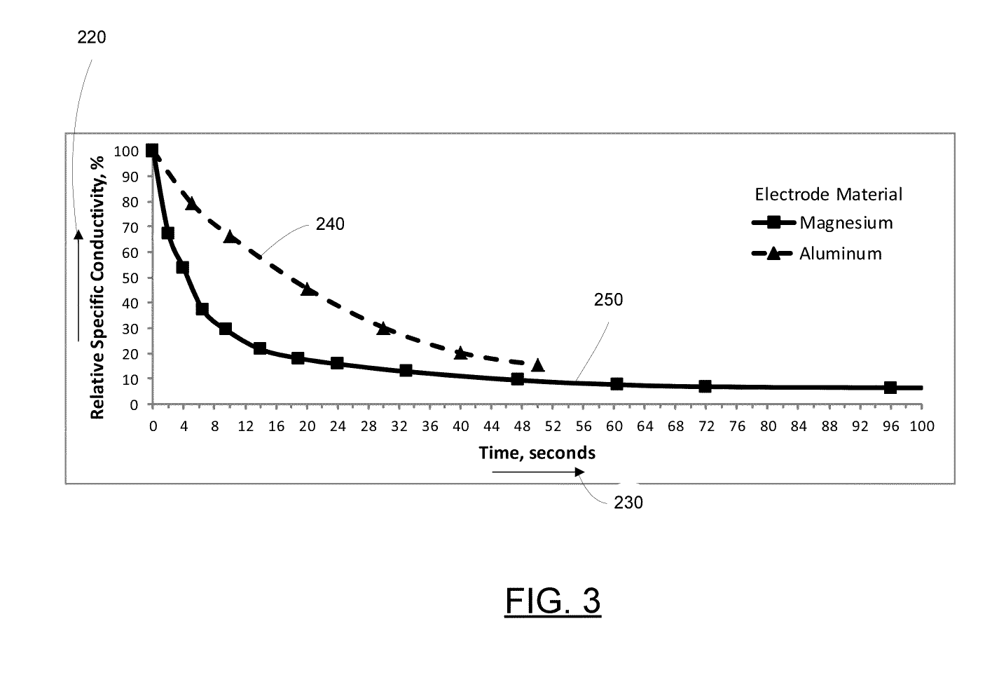

FIG. 3 is a graphical representation of relative water conductivity versus the duration of electric field treatment according to certain embodiments of the invention. The y-axis 220 shows the specific conductivity of treated water relative to the specific conductivity of the untreated water. The x-axis 230 represents the residence time, in seconds, a water volume element is subjected to the electric field in the ionic reactor. As shown in this graph, the extent of relative reduction of conductivity is depended upon the residence time or retention time the water is in the ionic reactor and exposed to the electric field. The aluminum curve 240 shows the results for an electrode comprising aluminum (Al) and the magnesium curve 250 shows the result for an electrode comprising magnesium (Mg). As both the aluminum curve 240 and the magnesium curve 250 show, increasing the residence time a water volume element is exposed to the electric field causes a greater reduction in ionic concentrations in the treated water. Additionally, the graph of FIG. 3 shows that a greater reduction in ionic concentrations for comparable residence times is realized when an electrode comprising magnesium is used to treat the water.

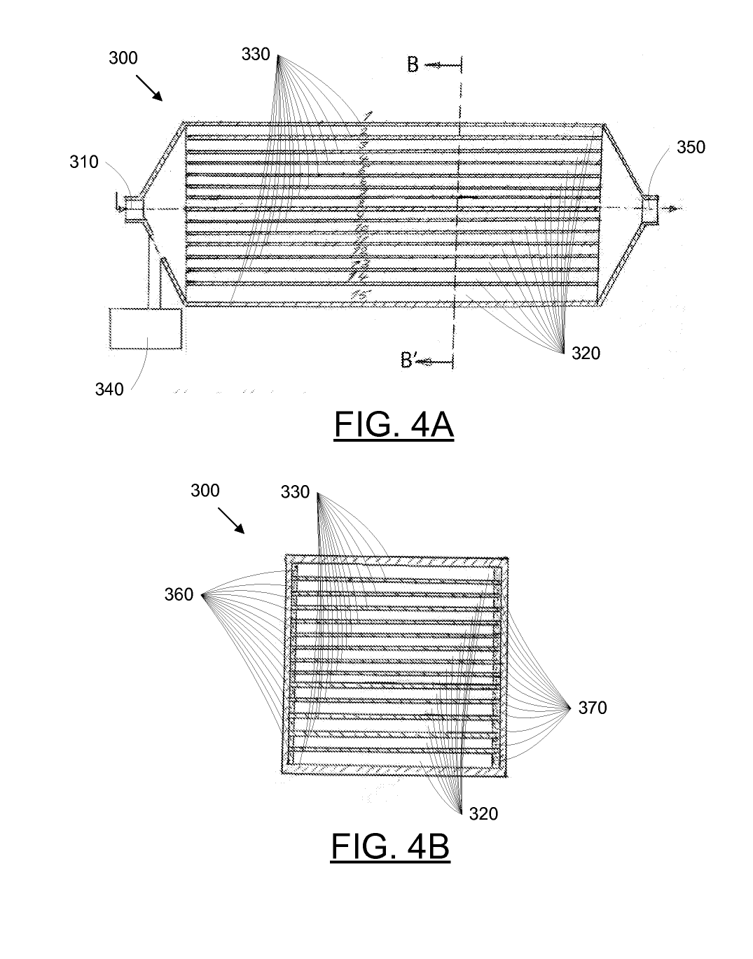

FIGS. 4A and 4B are representative of an exemplary embodiment of the invention illustrating a stack type, multi-cell ionic reactor. Without intending to be limiting, the stack type, multi-cell ionic reactor 300 represented by the illustrative embodiments of FIGS. 4A and 4B are typically configured to handle larger volumes of water to be processed for downstream use. FIG. 4A illustrates a cut-away side view of the stack-type, multi-cell ionic reactor 300 having an inlet 310 for the water to be treated. The stack type, multi-cell ionic reactor 300, as the name implies, is configured by stacking a plurality of single cell reactors or cells 320 on top of each other. The water may be distributed in parallel through the cells 320 of the ionic reactor 300, the cells 320 separated by electrodes 330, also acting as walls to define the cells 320, individually marked as 1-15 in this representative embodiment. The odd numbered electrodes 330 may be connected to one pole of a power source such as an AC source, for example, and the even numbered electrodes 330 may be connected to the other pole of the power source such as an AC source, for example.

An ultra-sonic transmitter 340 may be used to prevent the buildup of sediment layers along the electrodes 330 of the ionic reactor 300. Treated water exits the ionic reactor 300 at outlet 350.

The stack type, multi-cell ionic reactor 300 is defined by a cross section area, A₁, through which the water is configured to flow through the ionic reactor 300. Another cross-sectional area, A₂, is defined to be the smallest of the cross-sectional area of pipe defining the inlet 310 and the cross-sectional area of the pipe defining the outlet 350. The desired duration of retention time or residence time of water being treated in the stack type, multi-cell ionic reactor 300 may be established by setting a desired ratio of A₁ to A₂. For example, according to certain embodiments of the invention, the ratio of the cross sections between the reactor through which the water flows and the smallest of the cross sections of the inlet pipe and the outlet pipe, defined herein as A₁:A₂ may be from about 48:1 to about 1:1, from about 36:1 to about 4:3, from about 18:1 to about 2:1, and from about 9:1 to about 3:1.

In certain embodiments of the invention, the ionic reactor 300 may be configured to allow the water to flow through the cells 320 in series. In certain other embodiments of the invention, the ionic reactor 300 may be configured to allow the water to flow through the cells 320 having series and parallel arrangements. Without intending to be bound by theory, these types of arrangements may be used to increase the residence time a water volume element is subjected to the electric field in the ionic reactor 300.

FIG. 4B illustrates a cross-sectional view of the stack type, multi-cell ionic reactor 300 taken along the sectioning line BB′ of FIG. 4A. The cells 320 and electrodes 330 are illustrated in FIG. 4B. Additionally, this figure illustrates paired electrodes 360 & 370 that are disposed along the outside periphery of the cells 350. Each of the paired electrodes 360 & 370 would be supplied power through a power source (not shown) for generating an electric field in each of the cells 350.

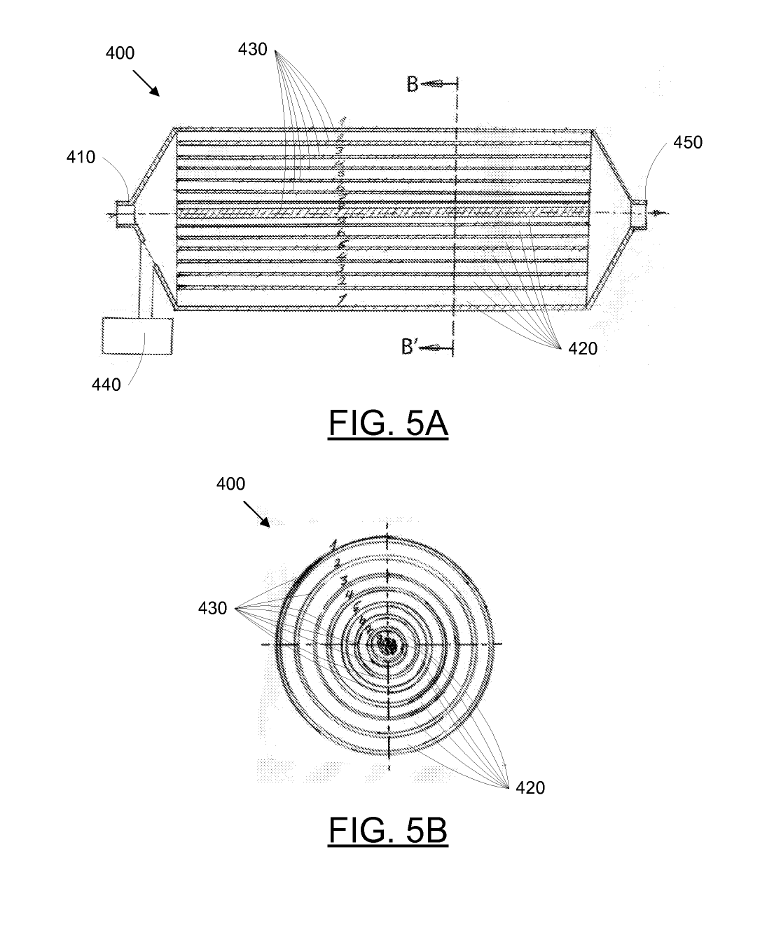

FIGS. 5A and 5B are representative of an exemplary embodiment of the invention illustrating another multi-cell ionic reactor. Without intending to be limiting, the stack type, multi-cell ionic reactor 400 represented by the illustrative embodiments of FIGS. 5A and 5B are typically configured to handle larger volumes of water to be processed for downstream use. The stack type, multi-cell ionic reactor 400 according to the illustrative embodiment represented in FIGS. 5A and 5B is configured to have a circular cross section through which the water flows. FIG. 5A illustrates a cut-away side view of the multi-cell ionic reactor 400 having an inlet 410 for the water to be treated. The water may be distributed in parallel through the cells 420 of the ionic reactor 400, the cells 420 configured in an annular arrangement separated by electrodes 430, also acting as walls to define the cells 420, individually marked as 1-8 in this representative embodiment. The even numbered electrodes 420 may be connected to one pole of a power source such as an AC source, for example, and the odd numbered electrodes 430 may be connected to the other pole of the power source such as an AC source, for example.

Alternatively, electrodes may disposed along either side of the walls defining the cells 420 with such electrodes being provided with power through a power source (not shown) for generating an electric field in each of the cells 420.

An ultra-sonic transmitter 440 may be used to prevent the buildup of sediment layers along the electrodes 430 of the ionic reactor 400. Treated water exits the ionic reactor 400 at outlet 450.

The stack type, multi-cell ionic reactor 400 is defined by a cross section area, A₁, through which the water is configured to flow through the ionic reactor 400. Another cross-sectional area, A₂, is defined to be the smallest of the cross-sectional area of pipe defining the inlet 410 and the cross-sectional area of the pipe defining the outlet 450. The desired duration of retention time or residence time of water being treated in the stack type, multi-cell ionic reactor 300 may be established by setting a desired ratio of A₁ to A₂. For example, according to certain embodiments of the invention, the ratio of the cross sections between the reactor through which the water flows and the smallest of the cross sections of the inlet pipe and the outlet pipe, defined herein as A₁:A₂ may be from about 48:1 to about 1:1, from about 36:1 to about 4:3, from about 18:1 to about 2:1, and from about 9:1 to about 3:1.

In certain embodiments of the invention, the ionic reactor 400 may be configured to allow the water to flow through the cells 420 in series. In certain other embodiments of the invention, the ionic reactor 400 may be configured to allow the water to flow through the cells 420 in series and parallel arrangements. Without intending to be bound by theory, these types of arrangements may be used to increase the residence time a water volume element is subjected to the electric field in the ionic reactor 400.

FIG. 5B illustrates a cross-sectional view of the stack type, multi-cell ionic reactor 300 taken along the sectioning line BB′ of FIG. 5A. The cells 420 and walls 430 are illustrated in FIG. 5B.

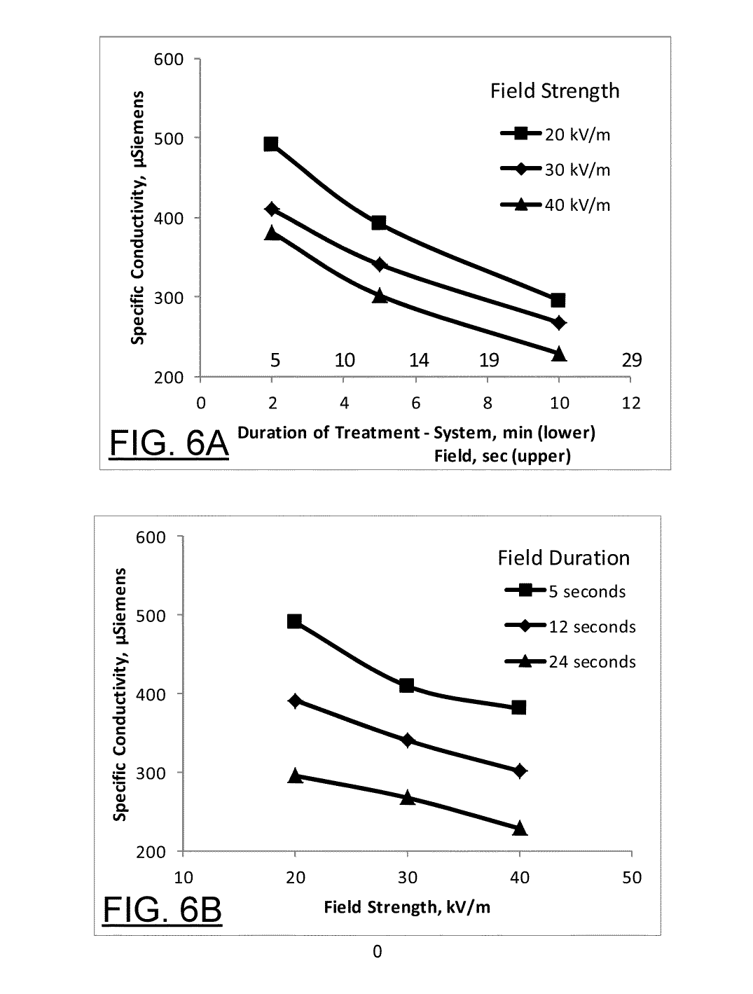

A series of tests were run using an ionic reactor having aluminum electrodes. Water having various concentrations of calcium carbonate was fed to the reactor at varying rates to achieve a desired length of time for the field treatment. Additionally, tests were conducted using field strengths of 20 kV/m, 30 kV/m, and 40 kV/m. The test apparatus was equipped with a sensor for measuring the conductivity of the treated water. The results for these tests are shown in FIGS. 6A, 6B, 7A, 7B, 8A, and 8B.

FIG. 6A is graphical representation of relative conductivity versus duration of treatment (both duration in a field and overall duration in the system) for varying field strengths of 20 kV/m, 30 kV/m, and 40 kV/m according to an embodiment of the invention. FIG. 6B is a graphical representation of relative conductivity measured in μSiemens versus field strength for varying durations of field treatments of 5 seconds, 12 seconds, and 24 seconds according to an embodiment of the invention. The concentration of calcium carbonate in the untreated water stream for both FIGS. 6A and 6B is 0.25 grams/liter. These figures show increasing field strengths and increasing durations of treatment result in a reduction in ionic concentrations in the treated water using aluminum as a substitution metal. However, in certain embodiments of the invention, according to the data of FIG. 3, it is more preferred to use magnesium as a substitution metal. In certain embodiments of the invention, the substitution metal may comprise magnesium and aluminum.

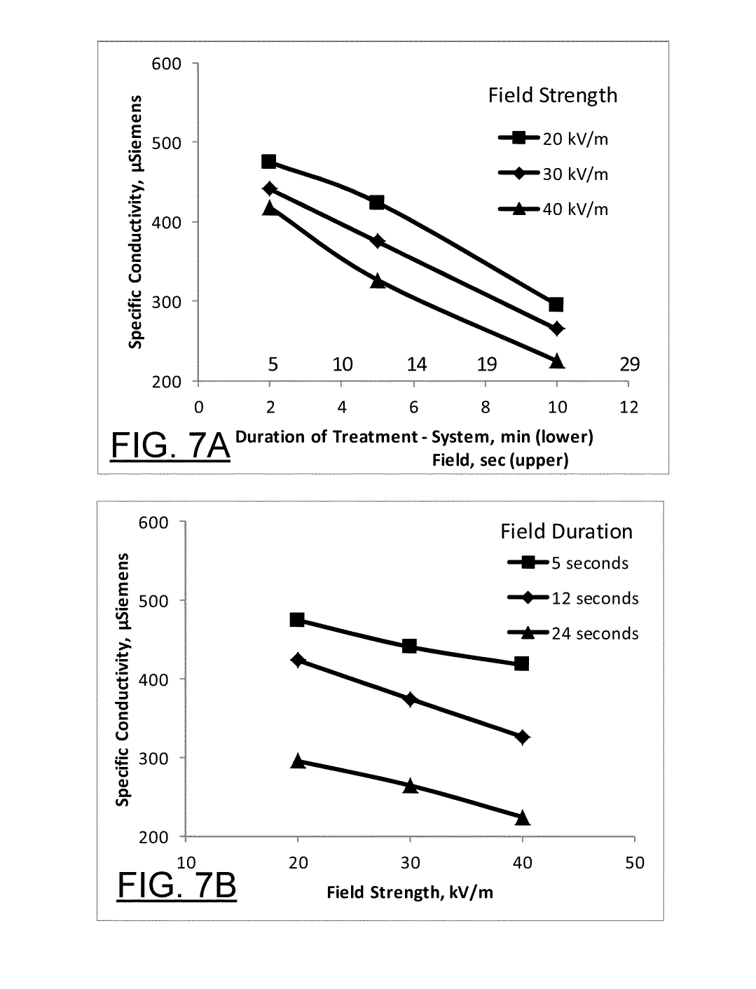

FIG. 7A is graphical representation of relative conductivity versus duration of treatment (both duration in a field and overall duration in the system) for varying field strengths of 20 kV/m, 30 kV/m and 40 kV/m according to an embodiment of the invention. FIG. 7B is a graphical representation of relative conductivity measured in μSiemens versus field strength for varying durations of filed treatments of 5 seconds, 12 seconds, and 24 seconds according to an embodiment of the invention. The concentration of calcium carbonate in the untreated water stream for both FIGS. 7A and 7B is 0.5 grams/liter. These figures show increasing field strengths and increasing durations of treatment result in a reduction in ionic concentrations in the treated water using aluminum as a substitution metal. However, in certain embodiments of the invention, according to the data of FIG. 3, it is more preferred to use magnesium as a substitution metal. In certain embodiments of the invention, the substitution metal may comprise magnesium and aluminum.

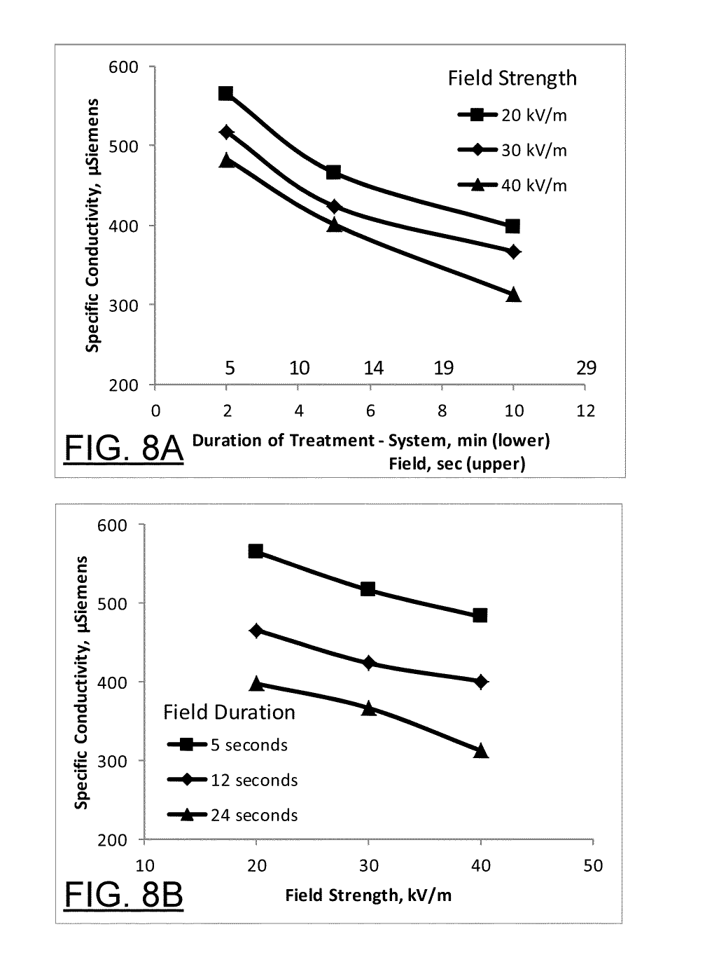

FIG. 8A is graphical representation of relative conductivity versus duration of treatment (both duration in a field and overall duration in the system) for varying field strengths of 20 kV/m, 30 kV/m and 40 kV/m according to an embodiment of the invention. FIG. 8B is a graphical representation of relative conductivity measured in μSiemens versus field strength for varying durations of filed treatments of 5 seconds, 12 seconds, and 24 seconds according to an embodiment of the invention. The concentration of calcium carbonate in the untreated water stream for both FIGS. 8A and 8B is 1 grams/liter. These figures show increasing field strengths and increasing durations of treatment result in a reduction in ionic concentrations in the treated water using aluminum as a substitution metal. However, in certain embodiments of the invention, according to the data of FIG. 3, it is more preferred to use magnesium as a substitution metal. In certain embodiments of the invention, the substitution metal may comprise magnesium and aluminum.

An aspect of the invention provides a system, a process and a method for the treatment of water. In particular, the system, the process, and the method incorporates the mechanisms as further defined herein for the substitution of Ca²⁺ with a metallic ion of a metal atom of an electrode and neutralizes the CO₃²⁻ and/or HCO₃⁻ by favorably supporting the collision of these negative ions with the metallic ion and providing the activation needed for the reaction to occur. Additionally, the system, the process, and the method may favorably support the collision of these negative ions with any unsubstituted Ca²⁺ ions and providing the activation needed for the reaction to occur. Of course, the system, the process, and the method of the invention would include the removal of any formed ionic compounds such as the metallic carbonate and any formed calcium carbonate prior to introducing the treated water to a downstream process.

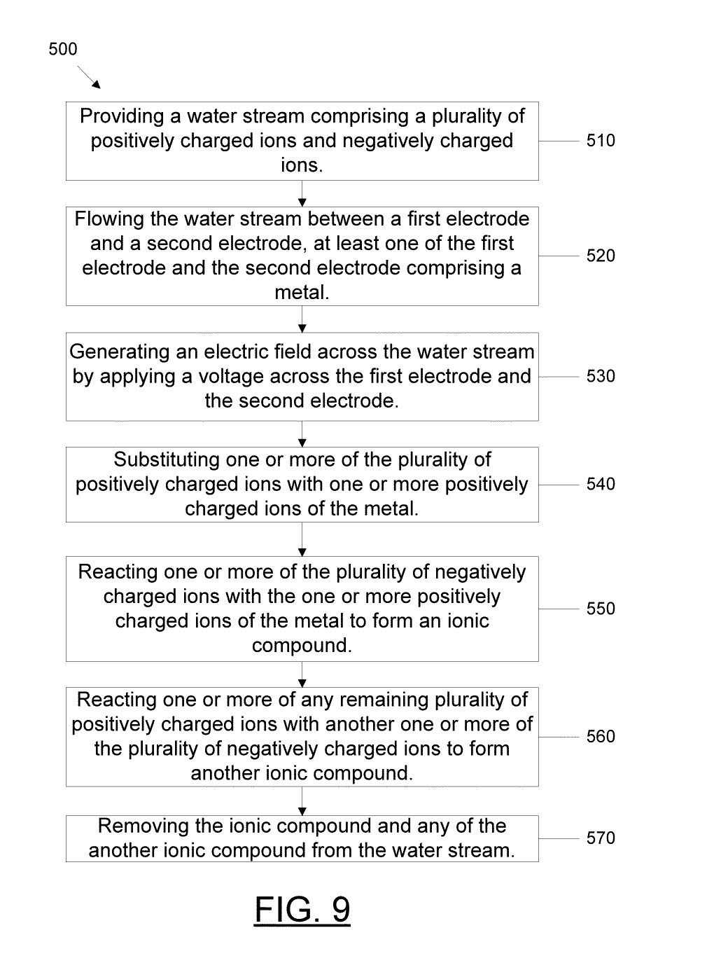

FIG. 9 is a process flow diagram showing the steps of a method for treatment of water according to an embodiment of the invention. The method for treatment of water 500 comprises providing a water stream comprising a plurality of positively charged ions and a plurality of negatively charged ions 510. Such positively charged ions and negatively charged ions may be, for example, mineral ions. Such mineral ions may be susceptible to combining and precipitating, for example, under varying conditions such as, for example, a change in temperature, a change in pressure, a change in alkalinity, or the like.

The method for treatment of water 500 further comprises the step of flowing the water stream between a first electrode and a second electrode, at least one of the first electrode and the second electrode comprising a metal 520, and generating an electric field across the water stream by applying a voltage across the first electrode and the second electrode to generate an electrical field across the water stream 530. The voltage typically is defined by a waveform.

The method for treatment of water 500 further comprises the step of substituting one or more of the plurality of positively charged ions with one or more positively charged ions of the metal 540. Such a method may additionally comprise the step of reacting one or more negatively charged ions with the one or more positively charged ions of the metal to form an ionic compound 550. Optionally, the method for the treatment of water 500 may include the step of reacting one or more of any remaining plurality of positively charged ions with another one or more of the plurality of negatively charged ions 560. The method for the treatment of water 500 may additionally comprise removing the ionic compound and any of the another ionic compound from the water stream 570.

In certain embodiments of the invention, an ordered arrangement of the steps of the method may be preferred. In other embodiments of the invention, the order of the steps is not necessarily fixed and may even occur substantially at about the same time. For example, the steps of flowing the water and generating the electric field may occur substantially at the same time and may be continuous, which is particular favorable for continuous processes.

In certain embodiments of the invention, the voltage may be an alternating voltage. In certain embodiments of the invention, the voltage or the alternating voltage may be configured to be a pulsed voltage. In certain embodiments of the invention, the waveform may be any one of a sinusoidal wave, a square wave, a trapezoidal wave, and any combination thereof.

According to an embodiment of the invention, the metal is aluminum. According to another embodiment of the invention, the metal is magnesium. Indeed, depending upon the type of metal, the step of reacting one or more negatively charged ions with the one or more positively charged ions of the metal to form an ionic compound 550 may be optional.

An aspect of the invention may also provide a treated water stream manufactured according to any of the methods of the invention.

### EXAMPLES

### Examples 1-2

Additional tests were conducted to determine the extent of reduction in ionic density or ionic concentration in an ionic reactor similar in configuration to that illustrated in FIG. 1. The extent of reduction is measured in terms of conductivity of the raw or untreated water entering the ionic reactor having an alternating electric field of 40 kV/m—see, for example, FIG. 3—relative to the conductivity of the treated water exiting the reactor. Example 1 shows the results for an ionic reactor having magnesium electrodes. Example 2 shows the results of for an ionic reactor having aluminum electrodes. The results of these tests are summarized in TABLE 1.

TABLE 1
Residence or Retention Time of Water in Electric
Field of Ionic Reactor (seconds)
(Intensity of Alternating Electric Field 40 kV/m)

Type of Electrodes

| | Example 1 | Example 2 |
|---|---|---|
| Conductivity of Treated Water | Magnesium | Aluminum |
| 50% of Raw Water | 5 | 18 |
| 25% of Raw Water | 12 | 34 |

As the data in TABLE 1 shows, under the conditions of these tests, without intending to be bound by theory, magnesium was a more effective substitution metal than aluminum.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. An ionic reactor comprising:
one or more cells, each cell comprising a pair of electrodes, at least one of the pair of electrodes having a metal;
a water stream comprising a plurality of positively charged ions and a plurality of negatively charged ions, the water stream flowing through the one or more cells; and
a voltage applied to the pair of electrodes to generate an electric field through the water stream,
wherein one or more of the plurality of positively charged ions are substituted by one or more positively charged ions of the metal.

2. The ionic reactor of claim 1, wherein one or more of the plurality of negatively charged ions are reacted with the one or more positively charged ions of the metal to form an ionic compound.

3. The ionic reactor of claim 2, wherein one or more of any remaining plurality of positively charged particles are reacted with another one or more of the plurality of negatively charged particles to form another ionic compound.

4. The ionic reactor of claim 3, further comprising a separator configured to separate the ionic compound and any of the another ionic compound from the water stream.

5. The ionic reactor of claim 1, wherein the voltage is an alternating voltage.

6. The ionic reactor of claim 1, wherein the voltage is defined by a waveform and the waveform is any one of a sinusoidal wave, a square wave, a trapezoidal wave, and any combination thereof.

7. The ionic reactor of claim 1, wherein the metal is any one of magnesium, aluminum, and any combination thereof.

8. The ionic reactor of claim 1, additionally comprising an ultrasonic transmitter to prevent the buildup of a sediment layer along the pair of electrodes.

9. A method for treatment of water comprising:
providing a water stream having a plurality of positively charged ions and negatively charged ions;
flowing the water stream between a first electrode and a second electrode, at least one of the first electrode and the second electrode comprising a metal;
generating an electric field across the water stream by applying a voltage across the first electrode and the second electrode; and
substituting one or more of the plurality of positively charged ions with one or more positively charged ions of the metal.

10. The method of claim 9, additionally comprising reacting one or more of the plurality of negatively charged ions with the one or more positively charged ions of the metal to form an ionic compound.

11. The method of claim 10, additionally comprising reacting one or more of any remaining plurality of positively charged ions with another one or more of the plurality of negatively charged ions to form another ionic compound.

12. The method of claim 11, additionally comprising removing the ionic compound and any of the another ionic compound from the water stream.

13. The method of claim 9, wherein the voltage is an alternating voltage.

14. The method of claim 9, wherein the voltage is defined by a waveform and the waveform is any one of a sinusoidal wave, a square wave, a trapezoidal wave, and any combination thereof.

15. The method of claim 9, wherein the metal is any one of magnesium, aluminum, and any combination thereof.

16. A system for the treatment of water comprising a reactor having:
one or more cells, each cell comprising a pair of electrodes, at least one of the pair of electrodes having a metal;
a water stream comprising a plurality of positively charged ions and a plurality of negatively charged ions, the water stream flowing through the one or more cells;
and a voltage applied to the pair of electrodes to generate an electric field through the water stream.
wherein one or more of the plurality of positively charged ions are substituted by one or more positively charged ions of the metal.

17. The system of claim 16, wherein one or more of the plurality of negatively charged ions are reacted with the one or more positively charged ions of the metal to form an ionic compound.

18. The system of claim 17, wherein one or more of any remaining plurality of positively charged particles are reacted with another one or more of the plurality of negatively charged particles to form another ionic compound.

19. The system of claim 18, further comprising a separator configured to separate the ionic compound and any of the another ionic compound from the water stream.

20. The system of claims 16, wherein the metal is any one of magnesium, aluminum, and any combination thereof.
